(19) United States
(12) Patent Application Publication
(10) Pub. No.: US 2011/0021144 A1
(43) Pub. Date: Jan. 27, 2011

(54) METHOD AND DEVICE FOR TESTING BLUETOOTH FUNCTION OF ELECTRONIC DEVICE

(75) Inventor: WEN-YI WU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/580,316

(22) Filed: Oct. 16, 2009

(30) Foreign Application Priority Data
Jul. 22, 2009 (CN) 200910304673.5

(51) Int. Cl. H04B 17/00; H04B 7/00

(52) U.S. Cl. 455/41.2; 455/67.14

(57) ABSTRACT

A method is used for a testing device to test the Bluetooth function of an electronic device and comprises the following steps. The testing device receives a password from the electronic device. The password is predetermined by the electronic device, and a first file is stored in the electronic device. The testing device sends the received password to the electronic device. The testing device receives the first file from the electronic device and saves as a second file. A third file is stored in the testing device. The testing device judges whether the second file is same as the third file.

### BACKGROUND

1. Technical Field

The present disclosure relates to methods and devices capable of testing electronic devices, and particularly to a method and a device capable of testing Bluetooth function of the electronic device.

2. Description of Related Art

Commonly, electronic devices, in particular, mobile telephones, are provided with a Bluetooth function. In order to ensure the Bluetooth function works properly before the electronic device is marketed, a manual testing method is used. However, the manual testing method is inconvenient and very time-consuming.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a plurality of electronic devices communicating with a testing device via a wireless network, in accordance with an embodiment.

FIG. 2 is a block diagram of the electronic device and the testing device of FIG. 1.

FIGS. 3(a)-3(b) are flow charts of a method for testing Bluetooth function of the electronic device of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

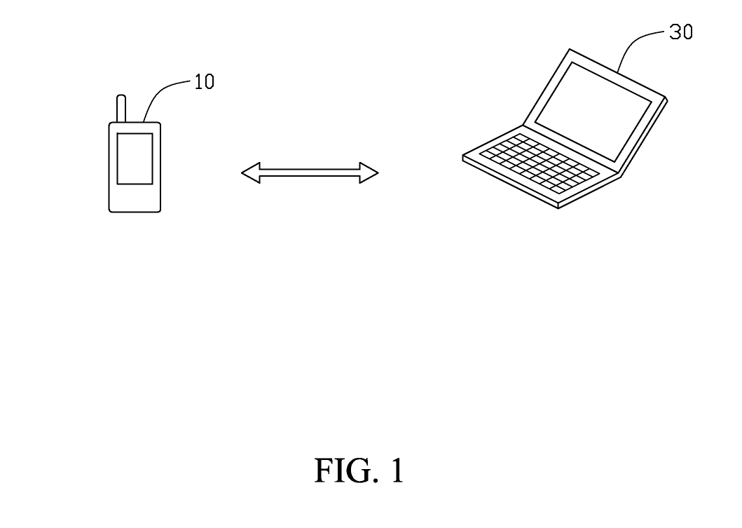

FIG. 1 illustrates a plurality of electronic devices 10 communicating with a testing device 30, in accordance with an embodiment. The electronic devices 10 are configured to perform Bluetooth functions, such as transmitting files to other electronic devices 10, etc. In one embodiment, the electronic devices 10 may be, for example, mobile telephones, personal digital assistants, smart telephones, etc. The testing device 30 is capable of testing whether the Bluetooth functions of the electronic device 10 are functioning correctly. In one embodiment, the testing device 30 may be, for example, a notebook computer, a desktop computer, a server computer, etc.

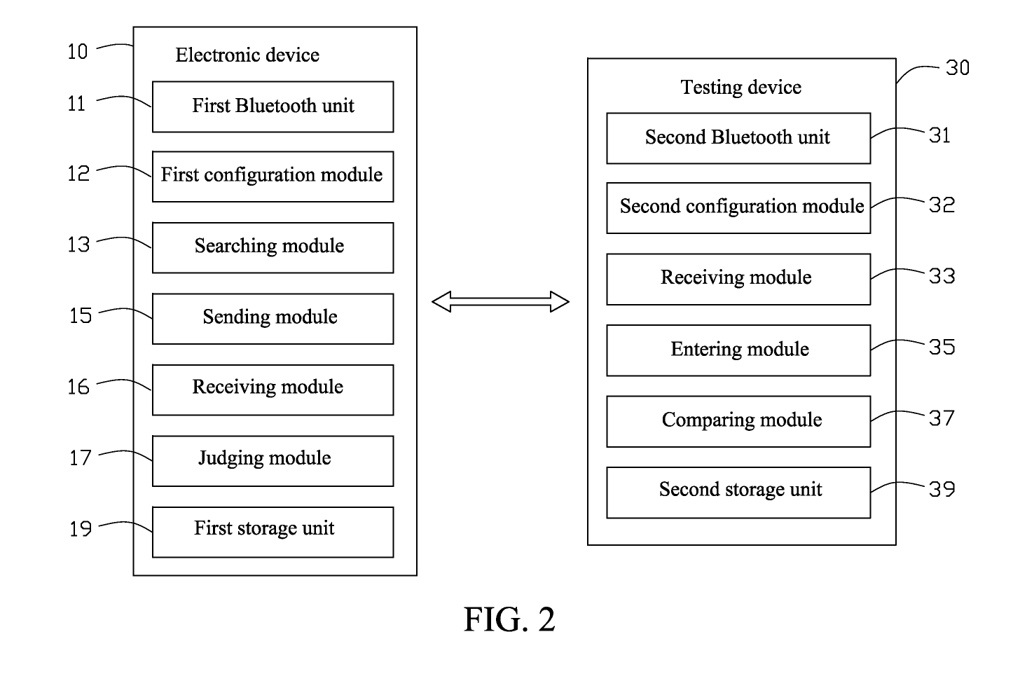

FIG. 2 illustrates one electronic device 10 including a first Bluetooth unit 11, a first configuration module 12, a searching module 13, a sending module 15, a receiving module 16, a judging module 17, and a first storage unit 19 with a file X stored therein. The first Bluetooth unit 11 is used to perform the Bluetooth functions of the electronic device 10. The first configuration module 12 is capable of configuring parameters of the first Bluetooth unit 11 and a password, with which the electronic device 10 can be accessed via the first Bluetooth unit 11. For example, the first configuration module 12 is capable of setting parameters that determines whether the first Bluetooth unit 11 is enabled or disabled and whether the first Bluetooth unit 11 can be found in the wireless network or not. In one embodiment, after the electronic device 10 is manufactured, the first configuration module 12 has set a predetermined password, and set so that the first Bluetooth unit 11 is enabled. The searching module 13 is capable of searching whether there are other devices in range. The sending module 15 is capable of sending information out of the electronic device 10. In one embodiment, the information includes, for example, the predetermined password and the file X in the first storage unit 19. The receiving module 16 is used to receive information sent to the electronic device 10. In one embodiment, the information may include, but not limited to, a password. The judging module 17 is used to judge whether an entered password received by the receiving module 16 matches the predetermined password configured by the first configuration module 12 and to decide whether the electronic device 10 can be accessed by other electronic devices 10 or the testing device 30.

FIG. 2 further illustrates the testing device 30 including a second Bluetooth unit 31, a second configuration module 32, a receiving module 33, an entering module 35, a comparing module 37, and a second storage unit 39 storing a file Y having the same content as the file X of the first storage unit 19 of the electronic device 10. The second Bluetooth unit 31 is capable of performing functions like the first Bluetooth unit 11 of the electronic device 10. The second configuration module 32 is capable of configuring parameters of the second Bluetooth unit 31. In one embodiment, the parameters determine whether the second Bluetooth unit 31 is enabled or disabled, and whether the second Bluetooth unit 31 can be found in the wireless network or not. The receiving module 33 is used to receive information sent to the testing device 30. In one embodiment, the information may include, but is not limited to, a file Z, which is the received file X sent from the electronic device 10 and received by the receiving module 33, and saved as to the testing device 30. The entering module 35 is used to enter the password received by the receiving module 33 and sent to the electronic device 10. The comparing module 37 is used to judge whether the file Z is same as the file Y, and to decide whether the electronic device 10 can be accessed by other electronic devices or the testing device 30.

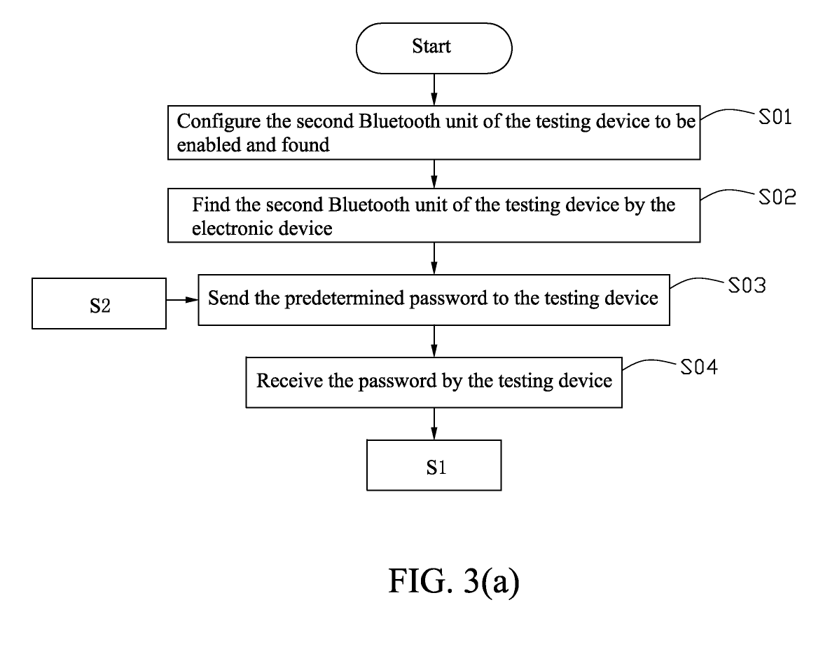

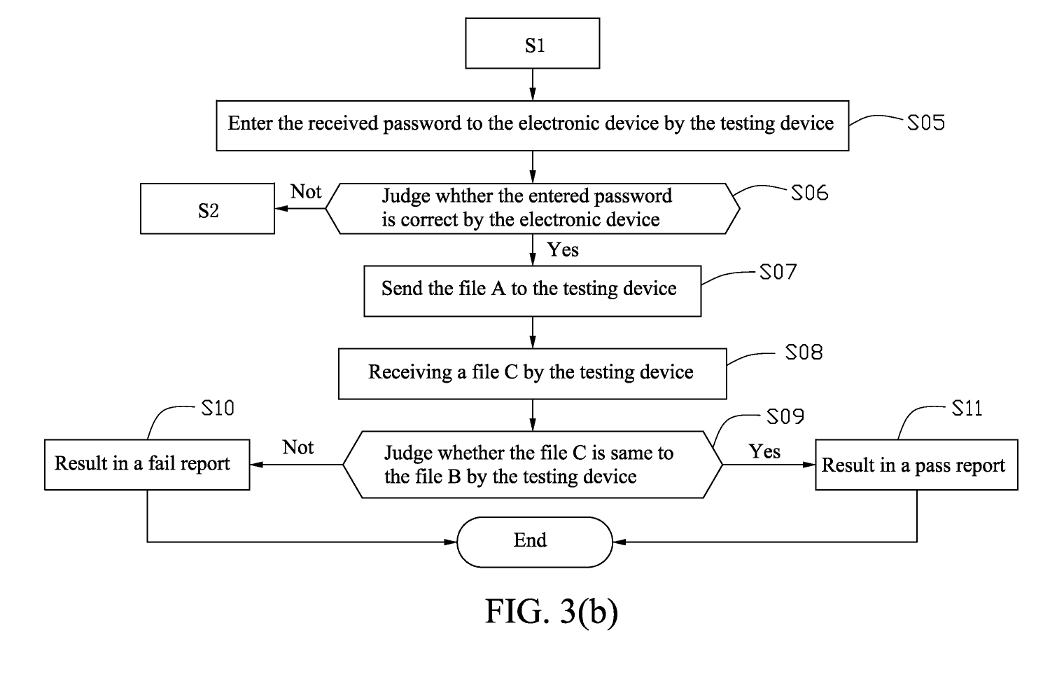

FIGS. 3(a) and 3(b) illustrate flow charts of a method for testing the Bluetooth function of the electronic device 10, in accordance with one embodiment.

In block S01, the second Bluetooth unit 31 of the testing device 30 is enabled and found respectively by the second configuration module 32.

In block S02, the searching module 13 of the electronic device 10 searches for and finds the testing device 30.

In block S03, the predetermined password is sent to the testing device 30 by the sending module 15.

In block S04, the receiving module 33 of the testing device 30 receives a password from the electronic device 10.

In block S05, the entering module 35 of the testing device 30 enters and sends the received password to the electronic device 10.

In block S06, the receiving module 16 of the electronic device 10 receives the entered password, and the judging module 17 of the electronic device 10 judges whether the entered password is correct.

If the entered password is wrong, then the procedure goes to block S03. Otherwise, if the entered password is correct, then the procedure goes to block S07 described below.

In block S07, the sending module 15 of the electronic device 10 sends the file X from the second storage unit 39 to the testing device 30.

In block S08, the receiving module 33 of the testing device 30 receives the file X from the electronic device 10, and save as a file Z in the second storage unit 39 of the testing device 30.

In block S09, the comparing module 37 of the testing device 30 judges whether the file Z matches the file Y in the second storage unit 39.

In block S10, if the file Z is different from the file Y, then the comparing module 37 reports failure of the Bluetooth functions of the electronic device 10.

In block S11, if the file Z matched the file Y, then the comparing module 37 report the Bluetooth functions of the electronic device 10 pass.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A method for a testing device to test the Bluetooth function of an electronic device, the method comprising:
receiving a password from the electronic device; wherein the password is predetermined by the electronic device, and a first file is stored in the electronic device;
sending the received password to the electronic device;
receiving the first file from the electronic device and saving the received first file as a second file; wherein a third file is stored in the testing device; and
judging whether the second file is same as the third file.

2. The method of claim 1, further comprising: if the second file is same as the third file, the Bluetooth function of the electronic device is considered acceptable.

3. The method of claim 1, further comprising: if the second file is different from the third file, the Bluetooth function of the electronic device is considered unacceptable.

4. The method of claim 1, further comprising: enabling a Bluetooth unit in the testing device before receiving the password.

5. The method of claim 4, further comprising: configuring the Bluetooth unit in testing device to be found after enabling the Bluetooth unit.

6. The method of claim 1, further comprising: storing the second file to a storage unit of the testing device before receiving the password.

7. A testing device usable to test Bluetooth function of an electronic device, the testing device capable of performing a method as following:
receiving a password from the electronic device by a testing device; wherein the password is predetermined by the electronic device, and a first file is stored in the electronic device;
sending the received password to the electronic device;
receiving the first file from the electronic device and saving the received first file as a second file; wherein a third file is stored in the testing device; and
judging whether the second file is same as the third file.

8. The testing device of claim 7, wherein the method further comprises: if the second file is same as the third file, the Bluetooth function of the electronic device is considered acceptable.

9. The testing device of claim 7, wherein the method further comprises: if the second file is different from the third file, the Bluetooth function of the electronic device is considered unacceptable.

10. The testing device of claim 7, wherein the method further comprises: enabling a Bluetooth unit in the testing device before receiving the password.

11. The testing device of claim 10, wherein the method further comprises: configuring the Bluetooth unit in the testing device to be found after enabling the Bluetooth unit.

12. The testing device of claim 7, wherein the method further comprises: storing the second file to a storage unit of the testing device before receiving the password.
